(19) United States
(12) Patent Application Publication
(10) Pub. No.: US 2015/0379944 A1
(43) Pub. Date: Dec. 31, 2015

(54) CURVED DISPLAY PANEL AND CURVED DISPLAY DEVICE

(71) Applicant: Shenzhen China Star Optoelectronics Technology Co., Ltd., Guangdong (CN)

(72) Inventors: Cheng-Hung CHEN, Guangdong (CN); Shih-Hsun LO, Guangdong (CN); Chuan WU, Guangdong (CN)

(21) Appl. No.: 14/382,697

(22) PCT Filed: Jul. 2, 2014
(86) PCT No.: PCT/CN2014/081523

§ 371 Date: Sep. 3, 2014

(30) Foreign Application Priority Data
Jun. 27, 2014 (CN) 201410301777.1

(51) Int. Cl. G09G 3/36; G09G 3/20

(52) U.S. Cl. CPC G09G 3/3607; G09G 3/3659; G09G 3/3688; G09G 3/3677; G09G 3/2003; G09G 2300/0452; G09G 2300/0465; G09G 2310/0205

(57) ABSTRACT

A curved display panel and a curved display device are provided. In the curved display panel, the long sides of the sub-pixel are parallel to the long frames of the panel, and the short sides of the sub-pixel are parallel to the short frames of the panel. Thus, the color cast can be reduced. Four sub-pixels of the pixel unit are arranged as a 2-by-2 matrix, and two sub-pixels in the same row are connected to the data lines, so that the problem of a non-uniform display can be solved.

### FIELD OF THE INVENTION

The present invention relates to the field of display panels, and particularly relates to a curved display panel and a curved display device.

### BACKGROUND OF THE INVENTION

In the field of a thin film transistor liquid crystal display (TFT-LCD) with a curve, the pixels of a display panel are generally arrayed by red, green, and blue (RGB) pixels, and colors are displayed by controlling gray scales of the RGB pixels. The display panel would be able to display more colors if the pixels are arrayed by white, red, green, and blue (WRGB) pixels.

Referring to FIG. 1, during a production of a traditional TFT-LCD with a curve, gate scanning lines 101 are parallel to long sides 100a of a curved display panel, and data lines 102 are perpendicular to the long sides 100a. Each long side of the pixels 11 is perpendicular to the long side 100a, and each short side of the pixels 11 is parallel to the long side 100a, wherein the curved display panel has a short side 110b, and the pixel has a short side 11b.

However, the WRGB pixels are arrayed along the same vertical direction, and the charging will be insufficient due to a larger number of data lines 102, so that the curved display panel has a non-uniform display. Referring to FIGS. 1b and 1c, a color filter 12 and a substrate 13 are shifted along a horizontal direction from a center of the curved display panel, so that a great relative displacement is formed between the color filter 12 and the substrate 13. The black matrixes are shaded by the great relative displacement, thus reducing an aperture ratio of the display. Therefore, the brightness is decreased on the right side and the left side of the display panel, and shadow areas are obviously shown on the sides. Referring to FIG. 1c, the color filter 12 and the substrate 13 are not shifted along the same direction, and they are expanded along opposite directions respectively. A color cast appears when a great relative displacement occurs, resulting in color shifts on the sides.

Therefore, it is necessary to provide another technical solution in order to solve the above problems.

### SUMMARY OF THE INVENTION

An object of the present invention is to provide a curved display panel and a curved display device such that the shadow areas and the color cast of the curved display panel can be reduced, and thus the aperture ratio can be improved. Furthermore, the sub-pixels are arranged as a 2-by-2 matrix, and the data lines can be reduced to reduce the cost of the material.

To achieve the above object, the present invention provides a technical solution as follows:

A curved display panel comprising a pixel structure disposed in the curved display panel, a plurality of data lines providing data signals to the pixel structure, and a plurality of scanning lines providing controlling signals to the pixel structure; the curved display panel comprises two first frames and two second frames adjacent to the first frames, and the first frames are curved and longer than the second frames, the scanning lines are perpendicular to the first frames and parallel to the second frames, and the data lines are perpendicular to the second frames and parallel to the first frames; the pixel structure comprises two or more pixel units; each of the pixel units comprises four sub-pixels, and the sub-pixels are a red sub-pixel, a green sub-pixel, a blue sub-pixel, and a white sub-pixel, and each of the pixel units is arranged as a 2-by-2 matrix, and two sub-pixels in the same row are connected to the data lines; each of the sub-pixels is a rectangle and has two long sides and two short sides, and the long sides are parallel to the first frames and perpendicular to the second frames, and the short sides are parallel to the second frames and perpendicular to the first frames.

In one embodiment of the curved display panel, the curved display panel further comprises two data driving circuits disposed on an outside of the first frames respectively, and the two data driving circuits provide data signals to one of the data lines at the same time.

In one embodiment of the curved display panel, the curved display panel further comprises two scanning driving circuits disposed on an outside of the second frames respectively, and the two scanning driving circuits provide scanning signals to one of the scanning lines at the same time.

In one embodiment of the curved display panel, the data driving circuit disposed on the outside of one of the first frames and the other data driving circuit disposed on the outside of another first frame are connected the same data lines.

In one embodiment of the curved display panel, the scanning driving circuit disposed on the outside of one of the second frames and the other scanning driving circuit disposed on the outside of another second frame are connected to the same scanning lines.

In one embodiment of the curved display panel, the data driving circuits are packaged by a chip-on-film method.

In one embodiment of the curved display panel, the scanning driving circuits are packaged by a chip-on-film method.

A curved display panel comprises a pixel structure disposed in the curved display panel, and a plurality of data lines providing data signals to the pixel structure; the curved display panel comprises two first frames and two second frames adjacent to the first frames, and the first frames are curved and longer than the second frames; the pixel structure comprises two or more pixel units; each of the pixel units comprises four sub-pixels, and the sub-pixels are a red sub-pixel, a green sub-pixel, a blue sub-pixel, and a white sub-pixel, each of the pixel units is arranged as a 2-by-2 matrix, and two sub-pixels in the same row are connected to the data lines; each of the sub-pixels is a rectangle and has two long sides and two short sides, the long sides are parallel to the first frames and perpendicular to the second frames, and the short sides are parallel to the second frames and perpendicular to the first frames.

In one embodiment of the curved display panel, the curved display panel comprises a plurality of scanning lines, and the scanning lines are perpendicular to the first frames and parallel to the second frames.

In one embodiment of the curved display panel, the data lines are perpendicular to the second frames and parallel to the first frames.

In one embodiment of the curved display panel, the curved display panel further comprises two data driving circuits disposed on an outside of the first frames respectively, and the two data driving circuits provide data signals to one of the data lines at the same time.

In one embodiment of the curved display panel, the curved display panel further comprises two scanning driving circuits disposed on an outside of the second frames respectively, and the two scanning driving circuits provide scanning signals to one of the scanning lines at the same time.

In one embodiment of the curved display panel, the data driving circuit disposed on the outside of one of the first frames and the other data driving circuit disposed on the outside of another first frame are connected to the same data lines.

In one embodiment of the curved display panel, the scanning driving circuit disposed on the outside of one of the second frames and the other scanning driving circuit disposed on the outside of another second frame are connected to the same scanning lines.

A curved display device comprising a curved display panel; the curved display panel comprises a pixel structure disposed in the curved display panel, and a plurality of data lines providing data signals to the pixel structure; the curved display panel comprises two first frames and two second frames adjacent to the first frames, and the first frames are curved and longer than the second frames; the pixel structure comprises two or more pixel units; each of the pixel units comprises four sub-pixels, and the sub-pixels are a red sub-pixel, a green sub-pixel, a blue sub-pixel, and a white sub-pixel, each of the pixel units is arranged as a 2-by-2 matrix, and two sub-pixels in the same row are connected to the data lines; each of the sub-pixels is a rectangle and has two long sides and two short sides, and the long sides are parallel to the first frames and perpendicular to the second frames, and the short sides are parallel to the second frames and perpendicular to the first frames.

In one embodiment of the curved display device, the curved display panel further comprises two data driving circuits disposed on an outside of the first frames respectively, and the two data driving circuits provide data signals to one of the data lines at the same time.

In one embodiment of the curved display device, the curved display panel further comprises two scanning driving circuits disposed on an outside of the second frames respectively, and the two scanning driving circuits provide scanning signals to one of the scanning lines at the time.

Compared to the prior art, in the curved display panel of the present invention, the sub-pixels of the pixel unit are arranged as a 2-by-2 matrix, and two sub-pixels in the same row are connected to the data lines, so that the data lines can be reduced by half thereby avoiding the problem of a non-uniform display. Furthermore, the long sides of each sub-pixel are parallel to the long frames of the curved display panel, and the short sides of each sub-pixel are perpendicular to the short frames of the curved display panel, thus the shadow areas and the color cast of the curved display panel can be reduced, and the problem of the non-uniform display can be solved.

### DESCRIPTION OF THE DRAWINGS

FIGS. 1a to 1c are schematic views of a traditional thin film transistor liquid crystal display with a curve;

FIG. 2 is a schematic view of a curved display panel according to a preferred embodiment of the present invention;

FIG. 3 is another schematic view of a curved display panel according to a preferred embodiment of the present invention;

FIG. 4 is a schematic view of a pixel structure in the curved display panel according to a preferred embodiment of the present invention;

FIGS. 5a and 5b are schematic views of a curved display panel according to a preferred embodiment of the present invention; and

FIG. 6 is a schematic view of a curved display device according to a preferred embodiment of the present invention.

### DETAILED DESCRIPTION OF THE PREFERRED EMBODIMENTS

Please refer to the drawings, wherein components having the same structure are represented by the same symbols. The following description is based on the specific illustrated embodiment of the present invention, which should not be construed as limiting the present invention, this is not discussed in detail in other specific embodiments.

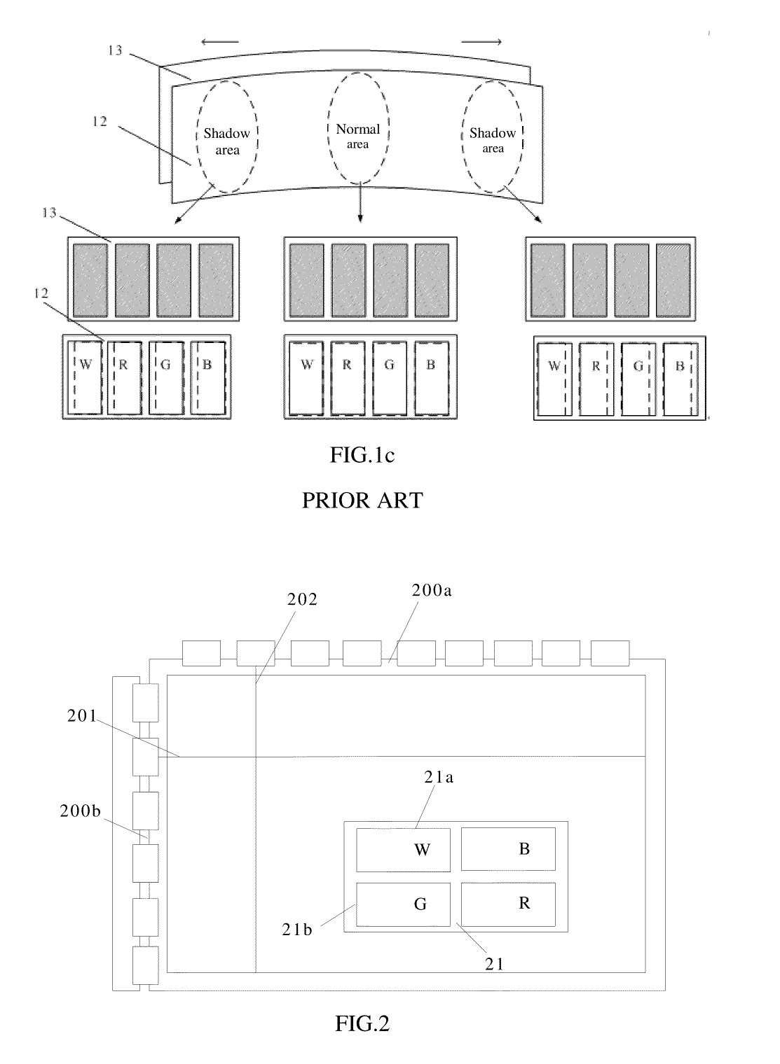

FIG. 2 is a schematic view of a curved display panel 200 according to a preferred embodiment of the present invention. The curved display panel 200 comprises a pixel structure disposed in the curved display panel 200 and a plurality of data lines 201 providing data signals to the pixel structure.

The curved display panel 200 further comprises two first frames 200a and two second frames 200b adjacent to the first frames 200a, and the first frames 200a are curved and longer than the second frames 200b.

The pixel structure comprises two or more pixel units 21, each of the pixel units 21 comprise four sub-pixels, and the sub-pixels are a red sub-pixel R, a green sub-pixel G, a blue sub-pixel B, and a white sub-pixel W. Each of the pixel units 21 is arranged as a 2-by-2 matrix, and two sub-pixels of the pixel units 21 in the same row are connected to the same one of the data lines.

Each of the sub-pixels is a rectangle and has two long sides 21a and two short sides 21b. The long sides 21a are parallel to the first frames 200a and perpendicular to the second frames 200b, and the short sides 21b are parallel to the second frames 200b and perpendicular to the first frames 200a.

It should be understood that FIG. 2 is only an exemplary schematic view of a pixel unit 21 of the curved display panel 200, and the present invention is not limited thereto.

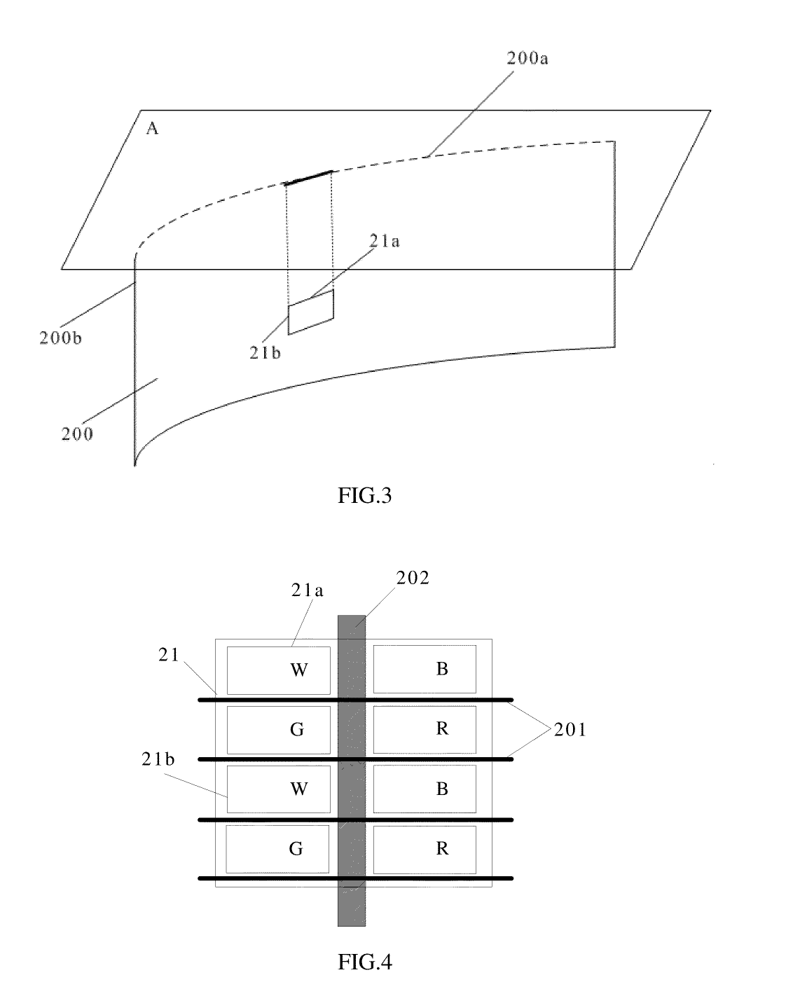

FIG. 3 is another schematic view of a curved display panel 200 according to a preferred embodiment of the present invention. The first frames 200a are curved frames, i.e. the long sides of the curved display panel 200. The second frames 200b are short sides of the curved display panel 200, and the second frames 200b are perpendicular to a plane A of the first frames 200a.

Referring to FIG. 3, the sub-pixel is disposed on the curved display panel 200, and the long sides 21a of the sub-pixel are perpendicular to the second frames 200b and parallel to the plane A. The short sides 21b of the sub-pixel are parallel to the second frames 200b and perpendicular to the plane A of the first frames 200a. It should be understood that the first frames 200a are curved frames, and the long sides 21a of the sub-pixel are shorter than the curved frames in FIGS. 2 and 3. In this embodiment of the present invention, the long sides 21a of the sub-pixel are parallel to the curved frames (first frames 200a), and the short sides 21b of the sub-pixel are perpendicular to the first frames 200a.

Moreover, referring to FIG. 2, the curved display panel 200 comprises scanning lines 202. The scanning lines 202 are perpendicular to the first frames 200a and parallel to the second frames 200b. The data lines 201 are perpendicular to the second frames 200b and parallel to the first frames 200a. The scanning lines 202 are parallel to the short sides 21b of the sub-pixel, and the data lines 201 are parallel to the long sides 21a of the sub-pixel. FIG. 4 is a schematic view of the data lines 201 and the scanning lines 202 and the pixel unit in the curved display panel according to a preferred embodiment of the present invention. FIG. 4, which is a schematic view of two pixels and the data lines 201 and the scanning lines 202, is exemplary only, and does not constitute undue limitation.

Referring to FIG. 2, in the curved display panel 200, each of the pixel unit 21 comprises four sub-pixels (WRGB), and the sub-pixels of the pixel unit 21 are arranged as a 2-by-2 matrix. Two sub-pixels of the pixel unit 21 in the same row are connected to the same one of the data lines and driven by the same data line. Referring to FIG. 4, compared to the pixel structure, the data lines of each pixel unit can be reduced by half, and the charging insufficiency can be avoided. Thus, the problem of a non-uniform display can be solved, and the cost of the material can be reduced.

In one embodiment of the present invention, the curved display panel 200 can control the scanning lines 202 and the data lines 201 in the following manner. If the curved display panel 200 is a Full-High-Definition panel (FHD), and has a resolution of 1920×1080 pixels, the curved display panel 200 needs 1080 scanning lines 202, and the scanning lines 202 are turned on and turned off once during the first frame period. Referring to FIG. 2, the scanning lines 202 of the pixel unit are turned on during one frame period, and the corresponding data signals of the data lines are provided to the four pixels. Referring to FIG. 4, during one frame period, the scanning line 202a is turned on, and the white sub-pixel W is charged and receives the data signal from the data line 201. The scanning line 202b is turned on, and the blue sub-pixel B is charged and receives the data signal from the data line 201. Other sub-pixels are driven in the same fashion, and it is not described redundantly.

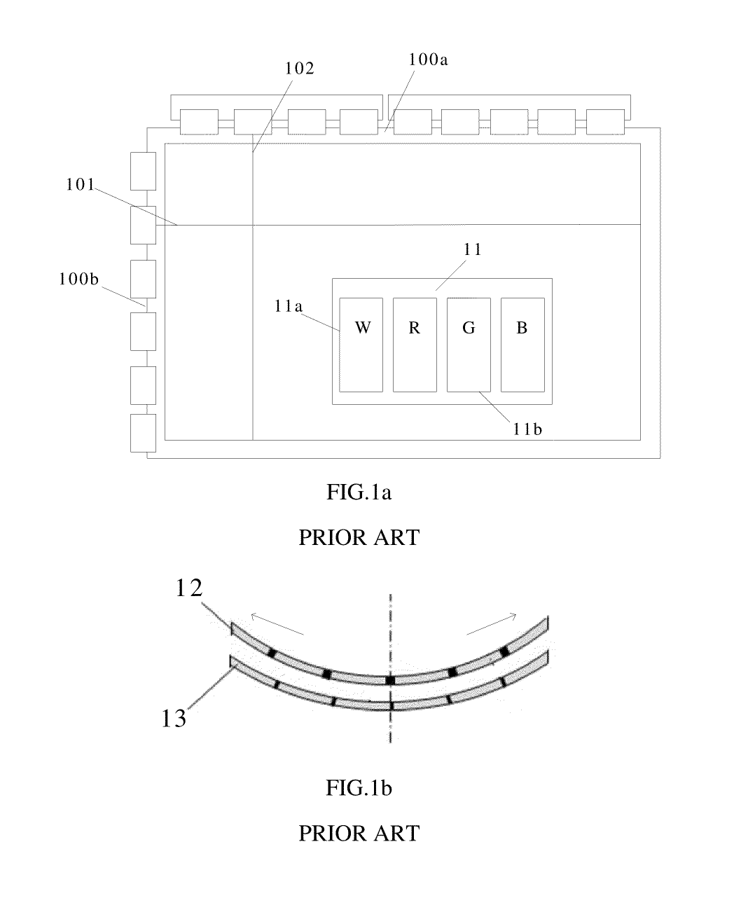

In the embodiment of the present invention, compared to the curved display panel of FIG. 1, each of the pixels is arranged horizontally, the long sides 21a of the pixel are parallel to the first frames 200a, and the short sides 21b of the pixel are parallel to the second frames 200b. Referring to FIGS. 2 and 3, the shadow areas and the color cast of the curved display panel 200 can be reduced, so that the problem of a non-uniform display can be solved.

In FIG. 2, the aperture area of the curved display panel is compared to the prior art of FIG. 1a. Referring to FIG. 1a, the gate scanning line 101 is parallel to long sides 100a of the curved display panel, and a data line 102 is perpendicular to the long sides 100a. The long sides 11a of the sub-pixel are perpendicular to the long sides 100a of the curved display panel. The long side 11a of the sub-pixel is m, and the short side 11b of the sub-pixel is n.

Referring to FIGS. 1b and 1c, the displacement of a sub-pixel is (s) urn, and the shadow area (loss of aperture area) is (m×s) um².

Referring to FIG. 2, the long sides 21a of each sub-pixel are parallel to the first frames 200a and perpendicular to the second frames, and the short sides 21b of each sub-pixel are parallel to the second frames 200b and perpendicular to the first frames. The scanning lines 202 are perpendicular to the first frames 200a and parallel to the second frames 200b. The data lines are perpendicular to the second frames 200b and parallel to the first frames 200a.

The aperture area at the same loss point by the same displacement is (m×s) um². However, m is much larger than n, so that the loss of aperture area of the present invention is much less than the prior art. Thus, the aperture ratio can be reduced and the display can be improved. The shadow areas and the color cast of the curved display panel can be reduced, and the problem of a non-uniform display can be solved.

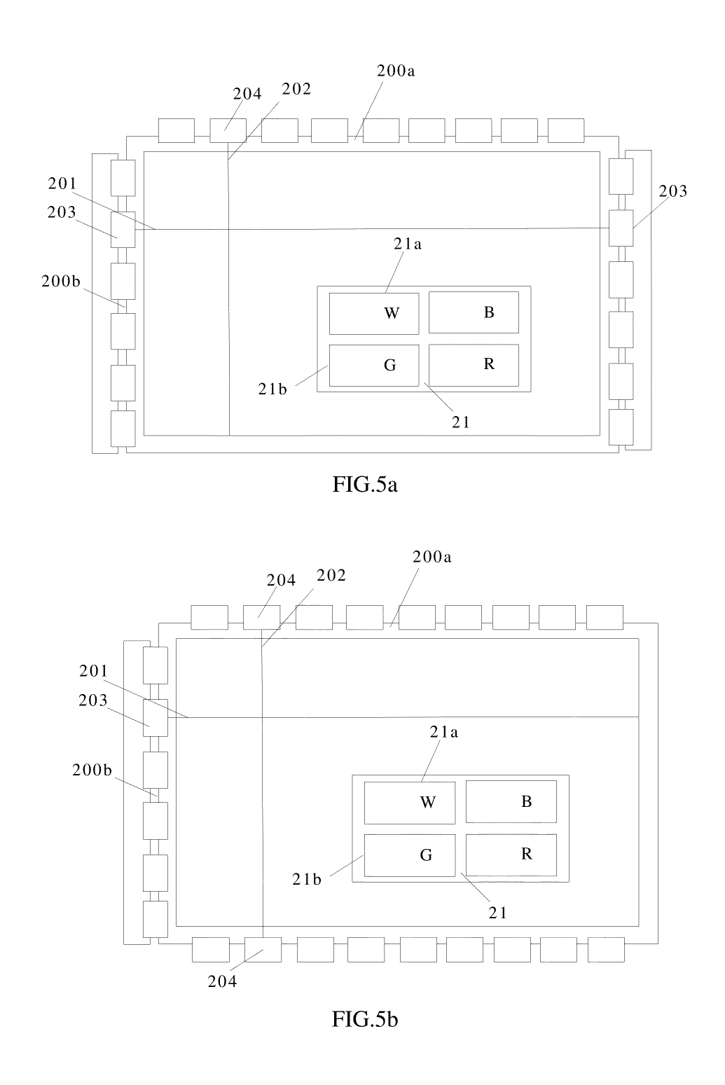

Compared to FIG. 1a, FIG. 5a is another schematic view of the curved display panel 200. The curved display panel 200 comprises two data driving circuits 203 disposed on two outsides of the first frames 200a respectively, and the two data driving circuits 203 provide data signals to one of the data line 201 at the same time, thus image distortion of the data line 201 can be improved.

Preferably, the data driving circuit 203 disposed on one outside of one of the first frames 200a and the other data driving circuit 203 disposed on another outside of another first frame 200a are connected to the same data lines 201. The two data driving circuits 203 provide identical signals, and the data driving circuits 203 are packaged by a chip-on-film (COF) method, so that the signals of the data lines 201 can be provided to the sub-pixels in the same row. The problem of the distortion of the data line can be solved.

FIG. 5b is another schematic view of the curved display panel 200. The curved display panel 200 comprises two scanning driving circuits 204 disposed on two outsides of the second frames 200b respectively, and the scanning driving circuits 204 provide scanning signals to one of the scanning lines 202 at the time, thus the problem of a non-uniform display can be solved.

The scanning driving circuit 204 disposed on one outside of one of the second frames 200b and the other scanning driving circuit 204 disposed on another outside of another second frame 200b are connected to the same scanning lines 202. Wherein the two scanning driving circuit 204 provide identical signals, and the scanning driving circuits 204 are packaged by a COF method. The scanning line 202 can provide controlling signals to the sub-pixels in the same row, thus the problem of a non-uniform display can be solved.

FIGS. 2, 5a, and 5b are only exemplary schematic views of the data line 201, the data driving circuit 203, the scanning line 202, and the scanning driving circuit 204. The present invention is not limited thereto.

As stated above, the curved display panel 200 of the present invention comprises four sub-pixels of each pixel unit 21, which are arranged as a 2-by-2 matrix, and two sub-pixels of each pixel unit 21 in the same row are connected to the same one of the data lines. Thus the data lines 201 can be reduced by half, the charging insufficiency and the non-uniform display can be avoided, and the cost of the materials can be reduced. Furthermore, the long sides 21a of each sub-pixel are parallel to the long frames 200a of the curved display panel, and the short sides 21b of each sub-pixel are perpendicular to the short frames 200b of the curved display panel. Thus, the shadow areas and the color cast of the curved display panel 200 can be reduced, the problem of a non-uniform display can be solved, and the cost of the materials can be reduced. Moreover, two data driving circuit 203 provide identical signals to the same data line 201, so that the data signal of the data line can be provided to the sub-pixels in the same row, and the problem of the distortion of the data line can be solved. Two scanning driving circuits 204 provide identical signals to the same scanning line 202, so that the scanning line 202 can provide controlling signals to the sub-pixels in the same row. Thus the problem of a non-uniform display can be solved.

For a better embodiment of the present invention, a preferred embodiment of the present invention further provides a curved display device comprising a curved display panel. Herein, the meaning of the terms used in the curved display panel above are the same, and the specific implementation details can refer to the instructions in the curved display panel.

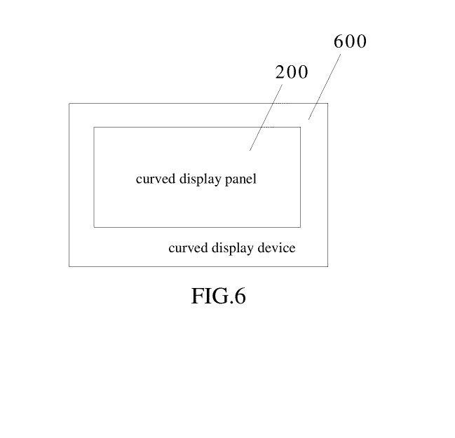

FIG. 6 is a schematic view of a curved display device 600 according to a preferred embodiment of the present invention, and the curved display device 600 comprises a curved display panel 200. The curved display panel 200 comprises a pixel structure disposed in the curved display panel 200 and a plurality of data lines 201 providing data signals to the pixel structure.

The curved display panel 200 further comprises two first frames 200a and two second frames 200b adjacent to the first frames 200a, and the first frames 200a are curved and longer than the second frames 200b.

The pixel structure comprises two or more pixel units 21, and each of the pixel units 21 comprises four sub-pixels, and the sub-pixels are a red sub-pixel R, a green sub-pixel G, a blue sub-pixel B, and a white sub-pixel W. Each of the pixel units 21 is arranged as a 2-by-2 matrix, and two sub-pixels of the pixel units 21 in the same row are connected to the same one of the data lines.

Each of the sub-pixels is a rectangle, and has two long sides 21a and two short sides 21b. The long sides 21a are parallel to the first frames 200a and perpendicular to the second frames 200b, and the short sides 21b are parallel to the second frames 200b and perpendicular to the first frames 200a.

It should be understood that FIG. 2 is only an exemplary schematic view of a pixel unit 21 of the curved display panel 200, and the present invention is not limited thereto.

FIG. 3 is another schematic view of a curved display panel 200 according to a preferred embodiment of the present invention. The first frames 200a are curved frames and long sides of the curved display panel 200. The second frames 200b are short sides of the curved display panel 200, and the second frames 200b are perpendicular to a plane A of the first frames 200a.

Referring to FIG. 3, the sub-pixel is disposed on the curved display panel 200, and the long sides 21a of the sub-pixel are perpendicular to the second frames 200b and parallel to the plane A. The short sides 21b of the sub-pixel are parallel to the second frames 200b and perpendicular to the plane A of the first frames 200a. Appreciate that the first frames 200a are curved frames, and the long sides 21a of the sub-pixel are shorter than the curved frames in FIGS. 2 and 3. In the embodiment of the present invention, the long sides 21a of the sub-pixel are parallel to the curved frames (first frames 200a), and the short sides 21b of the sub-pixel are perpendicular to the first frames 200a.

Moreover, referring to FIG. 2, the curved display panel 200 comprises scanning lines 202. The scanning lines 202 are perpendicular to the first frames 200a and parallel to the second frames 200b. The data lines 201 are perpendicular to the second frames 200b and parallel to the first frames 200a. The scanning lines 202 are parallel to the short sides 21b of the sub-pixel, and the data lines 201 are parallel to the long sides 21a of the sub-pixel. FIG. 4 is a schematic view of the data lines 201, the scanning lines 202, and the pixel unit in the curved display panel according to a preferred embodiment of the present invention. FIG. 4 is only an exemplary schematic view of two pixels, the data lines 201, and the scanning lines 202. The present invention is not limited thereto.

Referring to FIG. 2, in the curved display panel 200, each of the pixel unit 21 comprises four sub-pixels (WRGB), and the sub-pixels of the pixel unit 21 are arranged as a 2-by-2 matrix. Two sub-pixels of the pixel unit 21 in the same row are connected to the same one of the data lines and driven by the same data line. Referring to FIG. 4, compared to the pixel structure, the data lines of each pixel unit can be reduced by half, and the charging insufficiency can be avoided. Thus the problem of a non-uniform display can be solved, and the cost of the materials can be reduced.

In some embodiment of the present invention, the curved display panel 200 can control the scanning lines 202 and the data lines 201 in the following way. If the curved display panel 200 is an FHD panel, and has a resolution of 1920×1080 pixels, the curved display panel 200 needs to dispose 1080 scanning lines 202, and the scanning lines 202 are turned on and turned off once during the first frame period. Referring to FIG. 2, the scanning lines 202 of the pixel unit is turned on during a frame period, and the corresponding data signals of the data lines are provided to the four pixels. Referring to FIG. 4, during a frame period, the scanning line 202a is turned on, and the white sub-pixel W is charged and received the data signal from the data line 201. The scanning line 202b is turned on, and the blue sub-pixel B is charged and received the data signal from the data line 201. Other sub-pixels are driven in the same way as stated above, and the method is not described here redundantly.

In the embodiment of the present invention, compared to the curved display panel of FIG. 1, each of the pixels is arranged horizontally, the long sides 21a of the pixel are parallel to the first frames 200a, and the short sides 21b of the pixel are parallel to the second frames 200b. Referring to FIGS. 2 and 3, the shadow areas and the color cast of the curved display panel 200 can be reduced, so that the problem of a non-uniform display can be solved.

In FIG. 2, the aperture area of the curved display panel is compared to the prior art of FIG. 1a. Referring to FIGS. 1b and 1c, the displacement of a sub-pixel is (s) um, and the shadow area (loss of aperture area) is (m×s) um2.

Referring to FIG. 2, the aperture area at the same loss point by the same displacement is (m×s) um2. However, m is much larger than n, so that the loss of aperture area of the present invention is much less than the prior art. Thus, the aperture ratio can be reduced and the display can be improved. The shadow areas and the color cast of the curved display panel can be reduced, and the problem of a non-uniform display can be solved.

Compared to FIG. 1a, FIG. 5a is another schematic view of the curved display panel 200. The curved display panel 200 comprises two data driving circuits 203 disposed on an outside of the first frames 200a respectively, and the data driving circuits 203 provide data signals to the same data line 201. Moreover, the data driving circuit 203 disposed on one outside of one of the first frames 200a and the other data driving circuit 203 disposed on another outside of another first frame 200a are connected to the same data lines 201. The two data driving circuit 203 provide identical signals, and the data driving circuits 203 are packaged by COF method, so that the signals of the data lines 201 can be provided to the sub-pixels in the same row. In this way, the problem of the distortion of the data line can be solved.

FIG. 5b is another schematic view of the curved display panel 200. The curved display panel 200 comprises two scanning driving circuits 204 disposed on an outside of the second frames 200b respectively, and the scanning driving circuits 204 provide scanning signals to the same scanning line 202. Moreover, the scanning driving circuit 204 disposed on the outside of one of the second frames 200b and the other scanning driving circuit 204 disposed on the outside of another second frame 200b are connected to the same scanning lines 202. Wherein two scanning driving circuit 204 provide identical signals, and the scanning driving circuits 204 are packaged by COF method. The scanning line 202 can provide controlling signals to the sub-pixels in the same row, thus the problem of a non-uniform display can be solved.

FIGS. 2, 5a, and 5b are only exemplary schematic views of the data line 201, the data driving circuit 203, the scanning line 202, and the scanning driving circuit 204. The present invention does is not limited thereto.

As stated above, the curved display device 600 of the present invention comprises the above curved display 200, the four sub-pixels of each pixel unit 21 are arranged as a 2-by-2 matrix, and two sub-pixels of each pixel unit 21 in the same row are connected to the same one of the data lines. Thus, the data lines can be reduced by half, the charging insufficiency and the non-uniform display can be avoided, and the cost of the materials can be reduced. Furthermore, the long sides 21a of each sub-pixel are parallel to the long frames 200a of the curved display panel, and the short sides 21b of each sub-pixel are perpendicular to the short frames 200b of the curved display panel. Thus, the shadow areas and the color cast of the curved display panel 200 can be reduced, the problem of a non-uniform display can be solved, and the cost of the materials can be reduced. Moreover, two data driving circuits 203 provide identical signals to the same data line 201, so that the data signal of the data line can be provided to the sub-pixels in the same row, and the problem of the distortion of the data line can be solved. Two scanning driving circuits 204 provide identical signals to the same scanning line 202, so that the scanning line 202 can provide controlling signals to the sub-pixels in the same row. Thus, the problem of a non-uniform display can be solved.

In the above embodiment, the description of various embodiments have focused on a certain embodiment is not described in detail section, you can see the relevant description in other embodiments.

Furthermore, the word “preferably” used herein means serving as an example, a sample, or an illustration. Text described as “preferred” any aspect or design necessarily to be construed as advantageous over other aspects or designs. In contrast, the term “preferred”, is meant in particular the way the concept. As used herein, the term “or” is intended to mean containing “or” not exclude “or.” That is, unless specified otherwise, or clear from the context, “X employs A or B” means an arrangement of any nature, including. That is, if X employs A; X employs B; or X employs both A and B, then “X employs A or B” is met in any of the foregoing examples.

Moreover, despite being relative to one or more implementations shown and described the present disclosure, those skilled in the art based on the present specification and drawings will occur upon reading and understanding the equivalent variations and modifications. The present disclosure includes all such modifications and variations, and is only limited by the scope of the appended claims. Particularly, with regard to the various functions performed by the above-described components (e.g., elements, resources, etc.), the terms used to describe such components are intended to perform the function corresponding to the specified component (e.g., which is functionally equivalent) of any of the components (unless otherwise indicated), even if the structure of the implementation and execution of the function of the present disclosure shown herein disclosed exemplary not structurally equivalent. Additionally, although a particular feature of the present disclosure has been made with respect to certain implementations, only one is open, but this feature may be as given or particular application and the purpose of enabling a desired one or more other implementations Other combinations of features. Moreover, the terms “comprising,”, “having,”, “containing,” or variants thereof are used in the detailed description or the claims, such a term is intended to be used in a manner similar to the term “comprising”.

Although the present invention has been disclosed in the preferred embodiments described above, the foregoing preferred embodiments are not intended to limit the present invention. One of ordinary skill in the art, without departing from the spirit and scope of the present invention within, may make modifications and variations, so the scope of the protection of the invention is defined by the claims.

What is claimed is:

1. A curved display panel comprising a pixel structure disposed in the curved display panel, a plurality of data lines providing data signals to the pixel structure, and a plurality of scanning lines providing controlling signals to the pixel structure;
wherein the curved display panel comprises two first frames and two second frames adjacent to the first frames, and the first frames are curved and longer than the second frames, and the scanning lines are perpendicular to the first frames and parallel to the second frames, and the data lines are perpendicular to the second frames and parallel to the first frames;
wherein the pixel structure comprises:
two or more pixel units;
wherein each of the pixel units comprises four sub-pixels, and the sub-pixels are a red sub-pixel, a green sub-pixel, a blue sub-pixel, and a white sub-pixel, and each of the pixel units is arranged as a 2-by-2 matrix, and two sub-pixels in the same row are connected to the data lines;
wherein each of the sub-pixels is a rectangle and has two long sides and two short sides, and the long sides are parallel to the first frames and perpendicular to the second frames, and the short sides are parallel to the second frames and perpendicular to the first frames.

2. The curved display panel according to claim 1, wherein the curved display panel further comprises two data driving circuits disposed on an outside of the first frames respectively, and the two data driving circuits provide data signals to one of the data lines at the same time.

3. The curved display panel according to claim 1, wherein the curved display panel further comprises two scanning driving circuits disposed on an outside of the second frames respectively, and the two scanning driving circuits provide scanning signals to one of the scanning lines at the same time.

4. The curved display panel according to claim 2, wherein the data driving circuit disposed on the outside of one of the first frames and the other data driving circuit disposed on the outside of another first frame are connected to the same data lines.

5. The curved display panel according to claim 3, wherein the scanning driving circuit disposed on the outside of one of the second frames and the other scanning driving circuit disposed on the outside of another second frame are connected to the same scanning lines.

6. The curved display panel according to claim 2, wherein the data driving circuits are packaged by a chip-on-film method.

7. The curved display panel according to claim 3, wherein the scanning driving circuits are packaged by a chip-on-film method.

8. A curved display panel comprising a pixel structure disposed in the curved display panel, and a plurality of data lines providing data signals to the pixel structure;
wherein the curved display panel comprises two first frames and two second frames adjacent to the first frames, and the first frames are curved and longer than the second frames;
wherein the pixel structure comprises:
two or more pixel units;
wherein each of the pixel units comprises four sub-pixels, and the sub-pixels are a red sub-pixel, a green sub-pixel, a blue sub-pixel, and a white sub-pixel, and each of the pixel units is arranged as a 2-by-2 matrix, and two sub-pixels in the same row are connected to the data lines;
wherein each of the sub-pixels is a rectangle and has two long sides and two short sides, and the long sides are parallel to the first frames and perpendicular to the second frames, and the short sides are parallel to the second frames and perpendicular to the first frames.

9. The curved display panel according to claim 8, wherein the curved display panel comprises a plurality of scanning lines, and the scanning lines are perpendicular to the first frames and parallel to the second frames.

10. The curved display panel according to claim 8, wherein the data lines are perpendicular to the second frames and parallel to the first frames.

11. The curved display panel according to claim 8, wherein the curved display panel further comprises two data driving circuits disposed on an outside of the first frames respectively, and the data driving circuits provide data signals to one of the data lines at the same time.

12. The curved display panel according to claim 8, wherein the curved display panel further comprises two scanning driving circuits disposed on the outside of the second frames respectively, and the scanning driving circuits provide scanning signals to one of the scanning lines at the same time.

13. The curved display panel according to claim 11, wherein the data driving circuit disposed on the outside of one of the first frames and the other data driving circuit disposed on the outside of another first frame are connected to the same data lines.

14. The curved display panel according to claim 12, wherein the scanning driving circuit disposed on the outside of one of the second frames and the other scanning driving circuit disposed on the outside of another second frame are connected to the same scanning lines.

15. A curved display device comprising a curved display panel, wherein the curved display panel comprises a pixel structure disposed in the curved display panel, and a plurality of data lines providing data signals to the pixel structure;
wherein the curved display panel comprises two first frames and two second frames adjacent to the first frames, and the first frames are curved and longer than the second frames;
wherein the pixel structure comprises:
two or more pixel units;
wherein each of the pixel units comprises four sub-pixels, and the sub-pixels are a red sub-pixel, a green sub-pixel, a blue sub-pixel, and a white sub-pixel, and each of the pixel units is arranged as a 2-by-2 matrix, and two sub-pixels in the same row are connected to the data lines;
wherein each of the sub-pixels is a rectangle and has two long sides and two short sides, and the long sides are parallel to the first frames and perpendicular to the second frames, and the short sides are parallel to the second frames and perpendicular to the first frames.

16. The curved display device according to claim 15, wherein the curved display panel further comprises two data driving circuits disposed on the outside of the first frames respectively, and the data driving circuits provide data signals to one of the data lines at the same time.

17. The curved display device according to claim 15, wherein the curved display panel further comprises two scanning driving circuits disposed on the outside of the second frames respectively, and the scanning driving circuits provide scanning signals to one of the scanning lines at the same time.
